(19) United States
(12) Patent Application Publication
(10) Pub. No.: US 2008/0263022 A1
(43) Pub. Date: Oct. 23, 2008

(54) SYSTEM AND METHOD FOR SEARCHING AND DISPLAYING TEXT-BASED INFORMATION CONTAINED WITHIN DOCUMENTS ON A DATABASE

(75) Inventors: Evangelos P. Kostorizos, Arlington, MA (US); Alexander C. De Reitzes, New York, NY (US)

Correspondence Address: HINCKLEY, ALLEN & SNYDER, LLP, 11 SOUTH MAIN STREET, SUITE 400, CONCORD, NH, 03301, US

(73) Assignee: BLUESHIFT INNOVATIONS, INC., Arlington, MA (US)

(21) Appl. No.: 11/737,619

(22) Filed: Apr. 19, 2007

(51) Int. Cl. G06F 17/30; G06F 7/00; G06F 3/048

(52) U.S. Cl. 707/5; 707/7; 715/853; 707/E17.014; 707/E17.033

(57) ABSTRACT

This invention provides a system method for search and displaying text-based documents, based upon user-input search terms that organizes and displays documentary search results in a series of clusters of documents that have been sorted in a manner that relates to the general relevance of those documents to the search terms. In particular, this system and method allows for the searching of large databases of related documents by utilizing citations between those documents to improve search efficiency as well as visualization of search results. The document databases (DD) are used to generate a document connectivity index (DCI), of which a copy is stored on (or remotely accessed by) the client computer. The client issues a search request to a DD server, which returns a list of matching documents. The client compares this list against the DCI to generate a sorted list of document clusters. Using a graphical interface, the user can view and navigate these clusters to identify and view documents of interest. The clusters can be displayed as nodes in which each document is a node and the selected (or, by default, highest ranking) document/node is centered on the screen with linked documents placed around it with appropriate link lines (the surrounding node-and-link display). Each node can be activated to re-centered the nod-and-link display and show the underlying document text body.

### FIELD OF THE INVENTION

This invention relates to computer-based search engines, and more particularly to search engines that search and display text-based documents.

### BACKGROUND OF THE INVENTION

Long before the first human civilizations arose, early human ancestors had already developed a form of physical record keeping by painting on cave walls. In the intervening time, the human propensity to create physical records of information has not diminished. Along the way, humankind has made many advancements in record keeping procedures, information storage media technology, record duplication methods, and information dissemination methods. These advancements range from the library, card catalog, and standardized citation formats, to paper, ink, and the printing press. Such advancements, together with population growth and the devotion of more time to intellectual pursuits, have caused the growth rate of the totality of recorded human knowledge to increase with time. Most recently, the development of the personal computer and the Internet has led to the greatest acceleration of that growth rate yet. As an example of that growth, the World Wide Web consisted of about 20,000 servers in June of 1995; in June of 2005, it had approximately 60 million servers, and that number continues to climb. As evidence of the unprecedented growth of online information content, at the time of this writing the popular web search engine Google records over 5.3 billion web pages containing the word “the”.

The ability to store knowledge with greater reliability than human memory permits, together with the ability to efficiently pass knowledge from one person to another, and from each generation to the next has been instrumental in enabling the rapid pace at which society has developed and evolved throughout its history. However, in order to prevent the gradual degradation of society's information management efficiency, and by extension the overall pace of societal progression, it is necessary to continue finding new ways to more effectively navigate society's constantly growing knowledge repositories. As the total amount of recorded knowledge grows, so too does the need to rely on increasingly clever tools and systems for navigating that knowledge—the ability to store information with greater reliability is useless if it is impossible to single out a needed piece of information from the rest. Libraries, card catalogs, and systems for categorizing and sorting recorded knowledge (e.g. the Dewey decimal system) have long been the primary means by which the vast amounts of recorded knowledge are managed. However, the information explosion brought on by computers and the Internet has exceeded the information management capacity of these aging, traditional systems.

Fortunately, computers and the Internet are themselves superior information management tools (which is, in part, why they created such an information explosion in the first place). The ease with which one can alter a computer's operation simply by changing its software has created an environment in which the computer's efficiency as an information management tool is being continually improved. Because today's computer hardware is able to output information to a user faster than the user can absorb it, the speed of the computer's evolution as an information management tool is limited only by the time it takes someone to think of a better way to manage information, and to implement that methodology in computer code—there are no library shelves or card catalogs to be rearranged, no raw materials which must be collected and processed to create each new copy of a record.

It is amidst this fertile environment for improvement of information management technology that we now find ourselves. Prior art in this area invariably uses some type of text-based word-matching search algorithm. In these systems, the user inputs one or more words related to the search topic. The search engine then identifies relevant documents by matching the input words against the text of each document in whatever document database is being searched. By way of background, the most widely used implementation of a word-matching search engine is currently the Internet search engine Google.

Google allows a user to enter a string of one or more words, which it then compares against its database of over 5 billion web pages. Nearly instantaneously, Google returns a list of all the web pages that contain the same words as those entered by the user. Google augments this basic word-matching algorithm in two significant ways: firstly, it allows the user to define additional search parameters, including using Boolean “AND” and “OR” functions, confining the search to a specific web domain or host, restricting the search results to only those pages which match a complete phrase, and eliminating from the search results any pages containing additional user-specified words; secondly, it may identify a page as relevant despite an absence of words that match those specified by the user if the page contains a hyperlink to or from another page which meets certain search-related criteria. A hyperlink allows the user to navigate to the named site by clicking on the hyperlink text with a cursor or other interface mechanism.

Once Google has identified all of the pages that meet the search criteria, it uses a proprietary algorithm to estimate each page's relevance, which it uses to sort the search results in order of descending relevance. It then displays the titles of the first several search results, each title being a hyperlink to the original document. The user may then either follow one of these hyperlinks to view a document that interests him, or he may choose to view the next several search results if no document in the first group is satisfactory. With practice, a user can learn how to tailor his search criteria so that the first several results will usually contain at least one satisfactory document.

The speed with which Google returns search results indicates that in its current form, it should be able to handle search requests for an Internet containing several times the current number of web pages, or handle several times its current query load without experiencing a significant decrease in search speed. Accordingly, any innovation to improve the computational efficiency of the process for identifying documents relevant to a search would presently have a negligible impact on the efficiency with which a user can search a large collection of documents. However, such an innovation might reduce the amount of expensive computer hardware needed to host the search engine.

With the web currently growing at a rate of more than 10 million new servers per year, Google's search engine technology in its current form should be able to return search results nearly instantaneously for many years to come. However, the steady growth of the Internet will create a different problem for Google's search engine long before speed becomes a factor. As the Internet grows, so too will the number of web pages that Google returns for a given set of search criteria. As the number of search results increases, it will become increasingly difficult to home in on the specific page, or pages that are sought.

The severity of this problem is a direct function of the effectiveness of the algorithm used to estimate the relevance of a document. Theoretically, if there were a perfect algorithm that enabled a computer to read a user's mind, the number of search results returned would be irrelevant because the desired web pages would always be at the top of the search results. At the other extreme, if the search engine sorted the results randomly, the likelihood of a user finding the desired document would depend entirely on the number of search results returned. Even at a fraction of its present size, the web would contain enough pages that the average search would return too many documents to be useful without some method for sorting the results.

In order to maintain the effectiveness of an Internet search engine as the Internet continues to grow, it is necessary to develop better methods to estimate the relevance of each web page in the search results. Existing search engines use various text-based algebraic algorithms to estimate a document's relevance. Essentially, these algorithms “read” every word in every document in the database much faster than a human ever could by using shortcuts, including pre-generated indexes of various types. While a computer performs this task much better than a human can in terms of speed, it performs much worse in terms of understanding. Until artificial intelligence technology is able to make a computer understand linguistic meaning as a human can, these text-based algorithms will be limited to matching one word to another, letter by letter, and to examining syntax. Because an ideal text-based algorithm would require a computer to understand what it reads, there will be an upper limit to the effectiveness of a text-based sorting algorithm for as long as the artificial intelligence problem remains unsolved.

Within that limit, variation in the effectiveness of different algorithms derives from the accuracy with which each algorithm calculates an approximation of the similarity of the meaning of some text to the meaning of other text, using only contextual information. Such a calculation can use any of a document's quantifiable features, some examples of which include: the frequency of a search term's occurrence; the distribution of a search term's occurrences within the document; the average number of words between the occurrence of one search term and the occurrence of another; and the frequency with which some word appears in close proximity to a search term. In document databases in which one document can have a calculable relationship to another document, a meaning-approximation calculation may include in its input pertaining to one document the quantifiable features of a second, related document.

The vast majority of all search engines use only data derived from a subject document to estimate that document's relevance. In contrast, Google incorporates some related-document information into its estimation of a document's relevance; such information includes the frequency with which search terms appear in hyperlinks that link to the subject document from any other document, and the overall frequency with which other documents link to the subject document. Although it is possible to iterate the usage of data from related documents such that the calculation for one document may include features of a second document, which is related to the first document only through a chain of additional related documents, the inventors know of no specific prior art that uses such an algorithm.

Other than by improving a search engine's sorting algorithm, the severity of the problem the Internet's growth is expected to create may also be reduced by developing a better method for the user to browse the search results. In general, it is simply not practical to browse thousands, or even hundreds, of search results by reading through the list several results at a time. The graphical capabilities of today's computers allow information to be displayed in almost any way imaginable—there is no hardware limitation requiring that the search results be displayed as a text-based list. Despite this, every major search engine currently uses the text-based list format for displaying search results, a format that has not changed since the beginning of computerized search engines.

It is, thus, highly desirable to improve upon the weaknesses of existing search engines outlined above, by offering a system that is better designed to manage large sets of search results, and which takes full advantage of the computer's interactivity. While Internet search engines such as Google are most in need of such an innovation because of the Internet's rapid growth, it is recognized that a need exists to improve general information management systems that are used for exploring any electronic database comprised of individual elements that can be linked to each other in some way. Examples of such databases include: state and federal judicial opinions, which cite earlier rulings as precedent; scientific research papers, which cite earlier related studies; law enforcement and intelligence files on individuals of interest, in which the relationships between the individuals can expose hidden organizational structures; business entities and financial institutions, which have professional relationships that define the shape of the marketplaces in which they operate; and public health records, in which the contacts between individuals can be used to track the spread of a pathogen.

### SUMMARY OF THE INVENTION

This invention overcomes the disadvantages of the prior art by providing a system method for search and displaying text-based documents, based upon user-input search terms that organizes and displays documentary search results in a series of clusters of documents that have been sorted in a manner that relates to the general relevance of those documents to the search terms. In particular, this system and method allows for the searching of large databases of related documents by utilizing citations between those documents to improve search efficiency as well as visualization of search results. The document databases (DD) are used to generate a document connectivity index (DCI), of which a copy is stored on (or remotely accessed by) the client computer. The client issues a search request to a DD server, which returns a list of matching documents. The client compares this list against the DCI to generate a sorted list of document clusters. Using a graphical interface, the user can view and navigate these clusters to identify and view documents of interest.

In an illustrative embodiment, the DCI contains a series of entries that define incoming links and outgoing links for each document in the DD. Incoming links are links in which a subject referenced document is referenced within the text body of a referencing document, and that referencing document is listed as an incoming link entry for the subject document. Outgoing links are links in which the subject document references another document in the DD in the subject document's text body, and that referenced document is listed in the subject referencing documents outgoing link entry. Using these lists of entries, the client computer can conduct a search which, initially returns search results (documents) using conventional search techniques, and then builds clusters of documents by scanning the DCI entries for each of the results to thereby define, for each of the results a cluster of documents. The documents can be sorted by a variety of methods, one of which is by listing at a highest ranking the documents with the largest number of links. Theoretically, the most linked documents represent the most-relevant documents for a given search.

The clusters can be displayed as nodes on a graphical user interface (GUI) in which each document is a node and the selected (or, by default, highest ranking) document/node is centered on the screen with linked documents placed around it with appropriate link lines (the surrounding node-and-link display). The nodes can include a pattern, shape or other graphic that associates them with a given cluster (or no cluster). This pattern can be repeated in a textual list of clusters so the user may quickly select a given document in a given cluster. Text bodies for given documents can be displayed in an appropriate window for review. Each displayed node can be clicked-upon, or otherwise activated to center it (and its surrounding node-and-link display) within the display window. The text of the associated document for the node is thereby displayed in the text window. Each node may provide a pop-up window with statistics on the node/document when a cursor is applied to it. For example, the pop-up may include the cluster name, document title and date, number of links, search relevance score, source database, and/or some exemplary text surrounding the embedded search terms. The GUI includes a variety of functions that allow the display to be zoomed in or out to vary the number of nodes in the field of view as part of the overall-node-and-link display. Likewise, the number of links (the node diameter) away from a subject node can be filtered to add or omit nodes. In addition, the displayed nodes can be filtered based upon (a) the characteristics of the associated clusters, (b) lack of an associated cluster, or (c) lack of association of the node/document to a predetermined document database.

In an illustrative embodiment, the link lines can define a series of arrows or other graphical illustrations that identify whether one document/node is referenced by, or references another linked document/node. In various embodiments, the DCI is created by a DCI Index Generator, which scans the DD for documents and extracts citations to document titles (or other identifiers) in the appropriate format (a Text Handle) from each scanned document. Using this information, along with the tiled of each scanned document, the DCI Index Generator builds a set of incoming links and outgoing links for each document. When searched, the DCI entry for each document turned up in the search results is delivered associated with the search-result-document and used to retrieve other documents. This creates the cluster. The DCI can be stored locally on the client computer, or (particularly with smaller devices) is accessed from a remote server, which generates the SLDC and delivers it to a browser (for example) on the client device.

### BRIEF DESCRIPTION OF THE DRAWINGS

The invention description below refers to the accompanying drawings, of which:

FIG. 1 is a block diagram illustrating the overall system and method for citation based document searching in accordance with an illustrative embodiment of this invention;

FIG. 2 is a block diagram illustrating the data structure of a Document Connectivity Index used in accordance with this embodiment, and how it is derived from an exemplary Document Database;

FIG. 3 is a flow diagram showing a procedure by which the Document Connectivity Index is generated from the Document Database;

FIG. 4 is a flow diagram showing a procedure by which a sorted list of document clusters is generated from the Document Database and the Document Connectivity Index when the user initiates a search;

FIG. 5 is a state diagram illustrating a simple exemplary case of the process by which a sorted list of document clusters is generated from a list of search results and the Document Connectivity Index;

FIG. 6 is a diagram of a graphical user interface (GUI) screen display showing a representative implementation of a user interface for use with this system and method in graphical mode;

FIG. 7 is a flow diagram showing exemplary user interactions with the GUI screen display of FIG. 6;

FIG. 8 is a diagram of a GUI screen display showing a representative implementation of the user interface operating in a textual-display window mode;

FIG. 9 is a flow diagram showing exemplary user interactions with the GUI screen display of FIG. 8; and

FIG. 10 is a diagram of an exemplary group of nodes illustration a theory of operation related to the search procedure of the illustrative embodiment.

### DETAILED DESCRIPTION

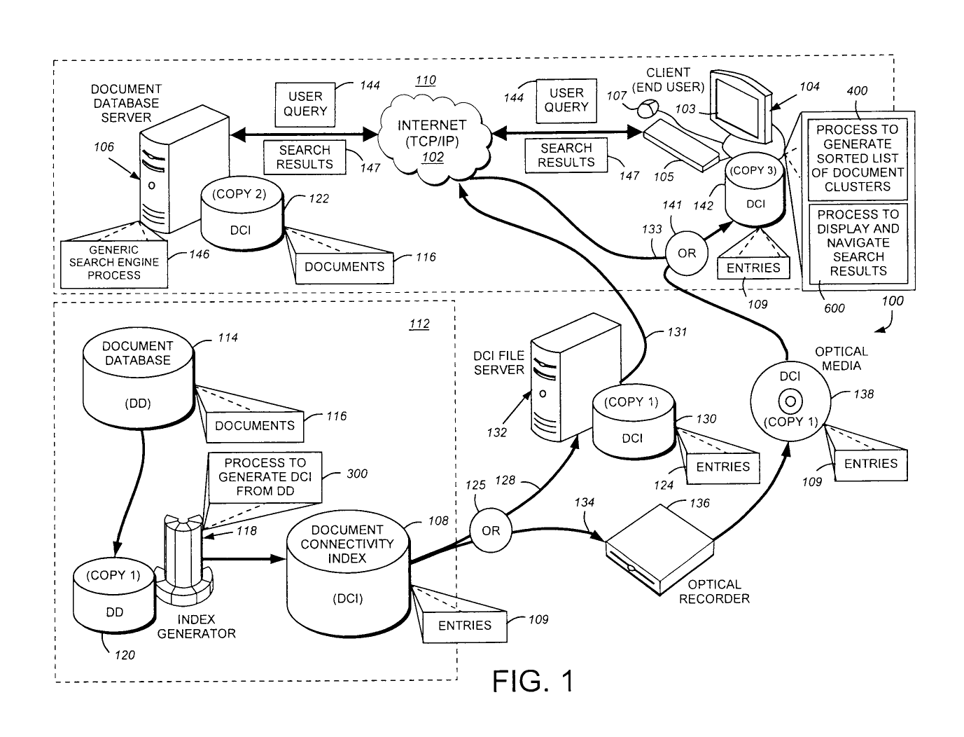

FIG. 1 details a simplified arrangement for a Document Database and Internet Network 100 for use by the system and method of this invention. A network enables communication by various computing devices through the Internet using an Internet Protocol (TCP/IP) network layer shown generally as the cloud 102. Included in the cloud 102, but not shown, is an interconnected plurality of routers, with the routers enabling the TCP/IP-layer address packets of digital information to pass from a source to a destination via the cloud. The principles governing these functionalities are well known.

An exemplary client 104 is shown. The client 104 is generally defined as a microcomputer having a display 103, a keyboard 105 for entering alphanumeric data, and a mouse 107, or similar human-machine interface (HMI) device for graphical-user-interface (GUI) data manipulation. Typically, the display supports a conventional GUI that facilitates more—intuitive interaction between a user and the computing device/network. Other types of Clients contemplated for use on the network, and in accordance with the teachings of this invention, can include (but are not limited to) handheld devices, such as personal data assistants or mobile phones, tablet-style computers, or laptop computers. In practice, hundreds of thousands of clients may be interconnected at various times to the network 100. A single client is shown for the purposes of this example and for simplicity.

Clients comprise end users. For the purposes of this example, the Client 104 represents an end user who wishes to locate database contents that meet search criteria specified by the end user (herein broadly defined as the set of database documents whose contents match the specified criteria in whole or in part). Also, for the purposes of this description, in the context of a proprietary database, the end user could be considered as a group or individual who purchases the right to access and search some or all of the database contents. Likewise, when conducting a search, the end user may specify a subset of the documents the end user is authorized to access. In an alternate embodiment, for non-proprietary databases the end user has unrestricted access to any publicly available database. In general, a group is a set of individual end users who collectively have the same right to access some or all of the database contents (employees of a business entity, a law firm, academic institutions, etc.).

The network connects to a Document Database Server 106. This server 106 can be a standalone computer system or a networked array of individual servers, as appropriate to the size and location of the stored documents. It is contemplated that the end user be able to query the contents of the entire Document Database Server 106 (hereinafter referred to as the “DD Server”), and that the client 104 will be able to retrieve the contents of any Document Connectivity Index (hereinafter referred to as the “DCI”) 108 (described further below), but the client 104 will only be able to retrieve the text contents of authorized documents. Of course, variations on this arrangement, which use well-known methods for authenticating end users, are also contemplated.

The networked system 100 comprises two major parts, Client interaction with the Document Database (hereinafter referred to as the “DD”) 114, symbolized by dashed-line box 110 and Creation of the DCI 108, symbolized by dashed box 112. It is contemplated that prior to Client interaction (110) with the DD 114, Creation (112) of the DCI 108 is performed, starting with storage media containing a selected DD 114. The DD is generally defined as a storage media containing a collection of text-based documents 116. In practice, hundreds of DD's may exist. A single DD is shown for the purposes of this example. The DD comprises both electronic documents and electronic copies of paper based documents. For the purposes of this example, the DD 114 is the set of documents contained in a pre-defined database selected by the Client 104 for the relevance of document content (herein defined as the set of text based documents related by a logical connection between the concepts expressed in the documents). Also for the purposes of this description, a DD 114 can be considered to be a collection of document databases grouped together based on a logical connection between concepts expressed in each database. For example, a database may be divided into several smaller subset databases allowing the end user to conduct a search on a single subset, or simultaneously across multiple subsets, including all of the database subsets. Furthermore, DD documents 116 may be static, or content changes may be updated immediately or periodically based on specified criteria (number of changes to DD, percentage of contents changed, regularly scheduled times, etc.). In general, concepts used to define a DD 114 are based on predetermined a hierarchy of criteria (IP address, URL, legal jurisdiction, field of research, language etc.). It is contemplated that the Client 104 selects the subject DD 114 or a group of subject DD's from a list of pre-defined DD possibilities. Variations on this arrangement, which use well known methods for creating an optimal database structure, are also contemplated.

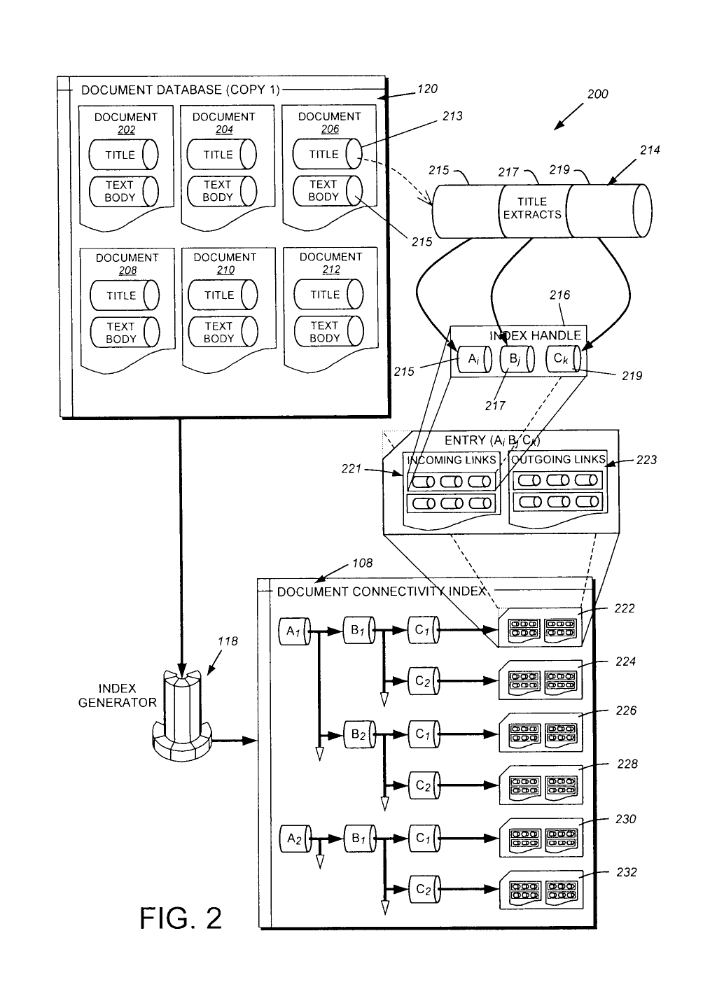

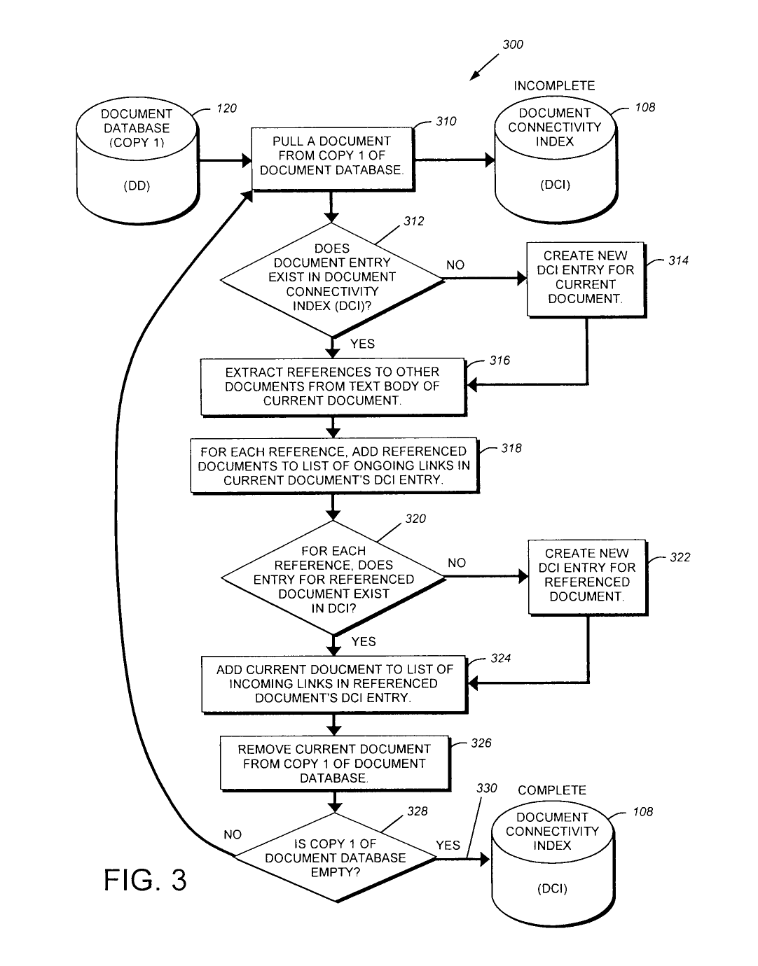

An Index Generator 118 and the DD 114 are used to create the DCI 108. Initially, complete copies of the DD 114 are stored locally on both the Index Generator 118 as DD (copy 1) 120 and on the DD Server 106 as DD (copy 2) 122 in an illustrative embodiment. Using the Process 300 (described below in FIG. 3) to generate the DCI 108 from the DD 114, the Index Generator 118 analyzes the data contained in DD (copy 1) 120, and creates the remotely stored versions of the DCI 108 (described below in FIG. 2 and FIG. 3). The DCI 108 is generally defined as a storage media containing entries 109 derived from simplified relational references contained within the subject database documents 116. In practice, a DCI 108 will exist for every DD, thus hundreds of corresponding DCIs may exist. In one implementation, the DCI can be distributed among a large number of discrete clients (e.g. a “distributed” DCI). A single DCI 108, and a single exemplary client 104, is shown for the purposes of this example. The DCI 108 comprises text-based relational references in a pre-defined format for every document in the DD 114, but does not include any other document-specific content. In other words, the DCI 108 only consists of the simplified relational references contained within the DD 114, and does not include any other text contained in database documents 116. For the purposes of this example the DCI 108 contains entries 109 for all relational references contained in the subject DD 114. Also for the purposes of this example, the DCI 108 can be considered to be a collection of indices grouped together based on the database structure of a multiple database DD. Furthermore, DCI entries may be static, or DD content changes may cause the DCI to be updated immediately or periodically based on specified criteria (number of changes to DD, percentage of contents changed, regularly scheduled times, etc.).

Generally, it is envisioned that the Process 300 to Generate the DCI 108 from the DD 114 may be run by the Index Generator 118 for the purposes of both generating a new DCI, or for periodic updates to a pre-existing DCI. In addition, both the DD Server 106 and Index Generator 118 computers can be any acceptable microcomputer, minicomputer, or mainframe according to this invention. In general, a microprocessor-based microcomputer with advanced file-serving capabilities is contemplated for the DD Server 106, while a microprocessor-based microcomputer with the ability to manipulate large data sets is contemplated for the Index Generator 118. The storage media in 108, 114, 120, and 122 are typically in the form of a disk drive or drives arrayed according to a variety of possible, known storage implementations.

Following the creation of the DCI 108, a copy 142 of the DCI is installed locally on the Client 104, minimizing the time required to render the search results and the amount of processing required by the DD Server 106. In an alternate embodiment, the DCI (142) may be stored only locally after the original DCI (108) is prepared by the index generator. Alternatively another application (a local application for example) can prepare the DCI using the DD information. This may be impractical, however where the communication speed and/or processing speed of the client 104 is limited. In this example, the DCI 108 is made available to the Client 104 via multiple formats (as symbolized by the “OR” operator 125). Two possible means of installing a local copy of the DCI on the Client are illustrated in this example. Following one path 128, DCI (copy 1) 130 is stored on the DCI File Server 132, from which the data of the main DCI 108 is then made available to the Client 104 for download via the network connections 131, 133 in and through the Internet 102 using, for example, a File Transfer Protocol (FTP) or similar mechanism for transferring a file between two computers. Following an alternate path 134, using an Optical Media Recorder 136, the DCI is recorded to media capable of being accessed by forms of removable storage available to the typical Client 104. Generally, the DCI (copy 2) 138 will be recorded on Optical Media, typically a CD-ROM, however other forms of magnetic and optical removable media, such as floppy disks or DVDs, are also contemplated. Finally, the Client 104 selects the desired format (as symbolized by the “OR” operator 141), and DCI (copy 3) 142 is stored locally on the Client 104. It is contemplated that the storage media in 130 and 142 are typically in the form of a disk drive or drives. Of course, variations on this arrangement, which use well-known methods for distributing the DCI data, are also contemplated. For example, in an alternate embodiment, the DCI can be cached and maintained on a remote source, such as a dedicated server (not shown) that provides the up-to-date DCI information whenever needed by the client 104 based on a query to the server over, for example a client browser.

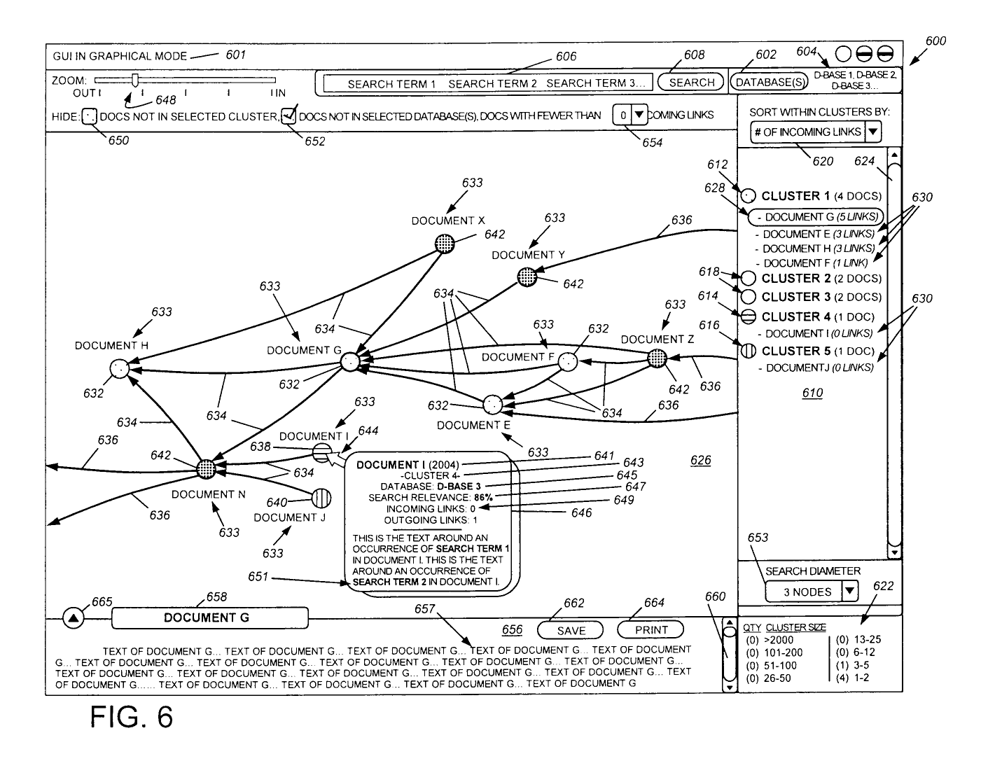

The second major part of the system 100, Client interaction with the database (110), occurs following the installation of DCI (copy 3) 142 on the Client 104 or a vehicle, by which a remotely stored DCI data can be readily retrieved from a remote source by the user (such as a browser application on the Client 104). Initially, the end user enters search criteria into a simple graphical user interface 600 (described in detail below in FIG. 6) run on the Client 104 and displayed on the client display 103. Search criteria are generally defined as data that indicates the subject and scope of the search. In this example, search criteria are shown as the User Query 144 that pass through the network connections (via the Internet 102 in this example) to the DD Server 106. The end user inputs the search subject by typing text into a form field on the GUI 600, while the search scope is determined by the end user selecting a pre-defined document database or databases for the search. In practice, the end user may input any combination of text and databases. For the purposes of this example, the Client converts the search criteria into a format that is commonly used for searching the contents of a database, such as Structured Query Language (SQL), after which the User Query 144 is transmitted to the DD Server 106 via the network connections represented by the Internet 102. Upon receipt of the User Query 144, the DD Server 106 applies a generic search engine process 146 to its version of the DD (copy 2) 122. In this embodiment, the generic search engine 146 is contemplated to be any process used by the DD Server 106 to automate the identification of database contents that match the search subject. Examples of search engines include traditional Boolean searches, the statistical analysis of word frequency, or a combination of other factors. Moreover, the generic search engine 146 can be database specific, or can be a large scope engine such as the one provided by Google. Of course, variations on this arrangement, which use well-known methods for identifying documents of interest, are also contemplated.

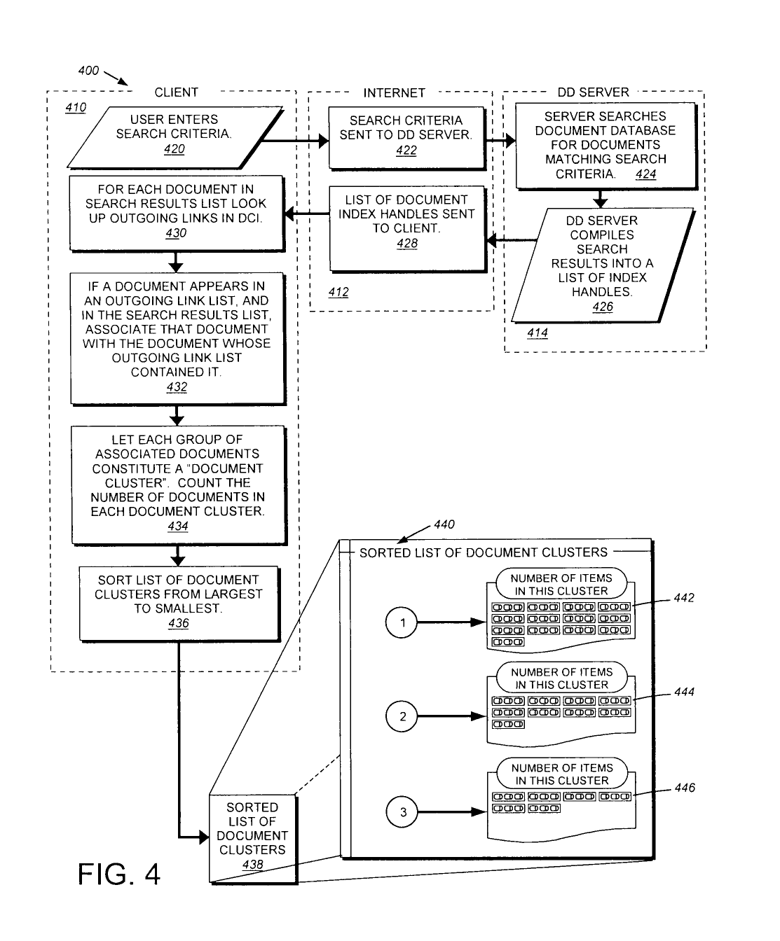

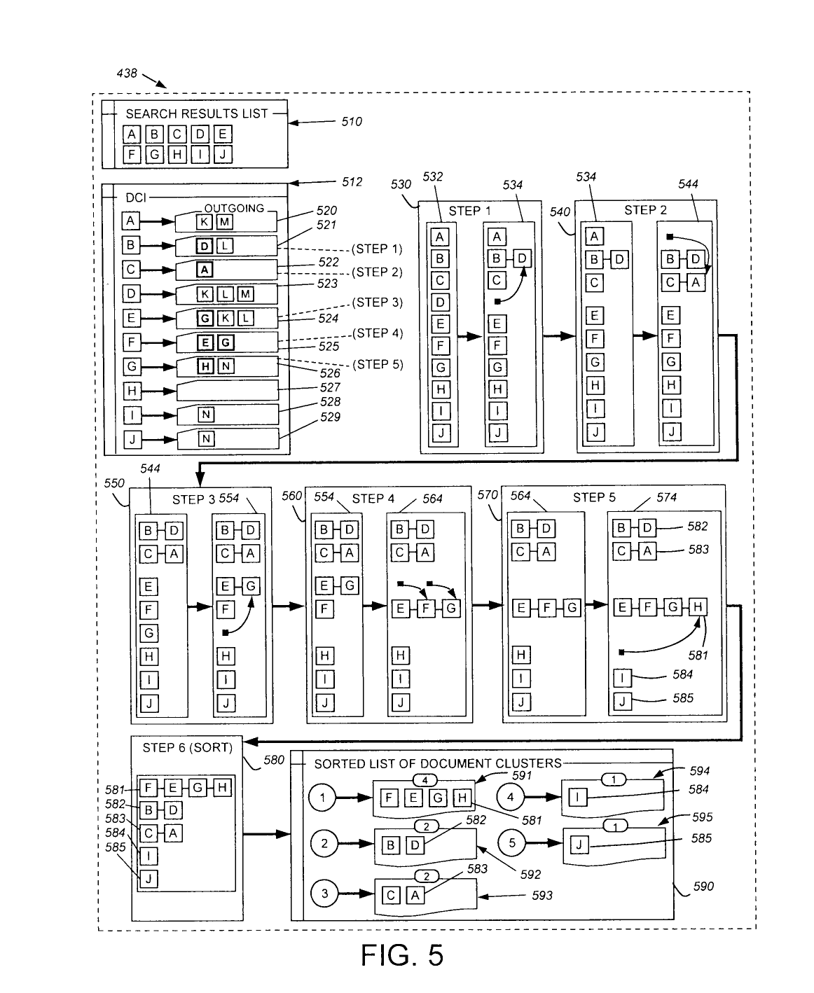

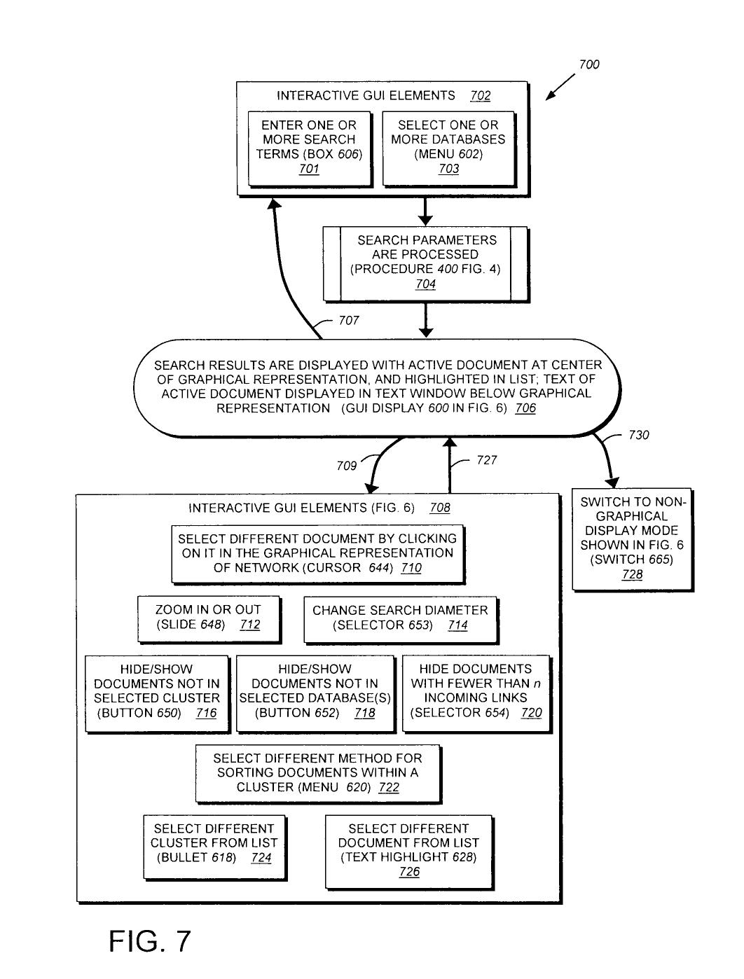

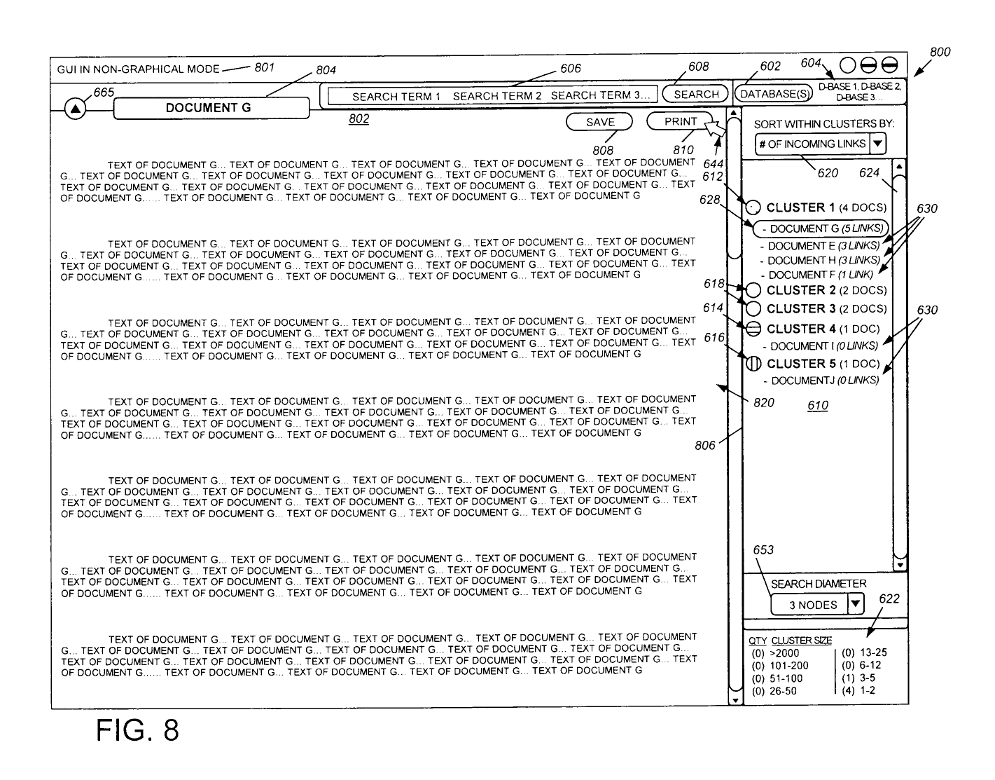

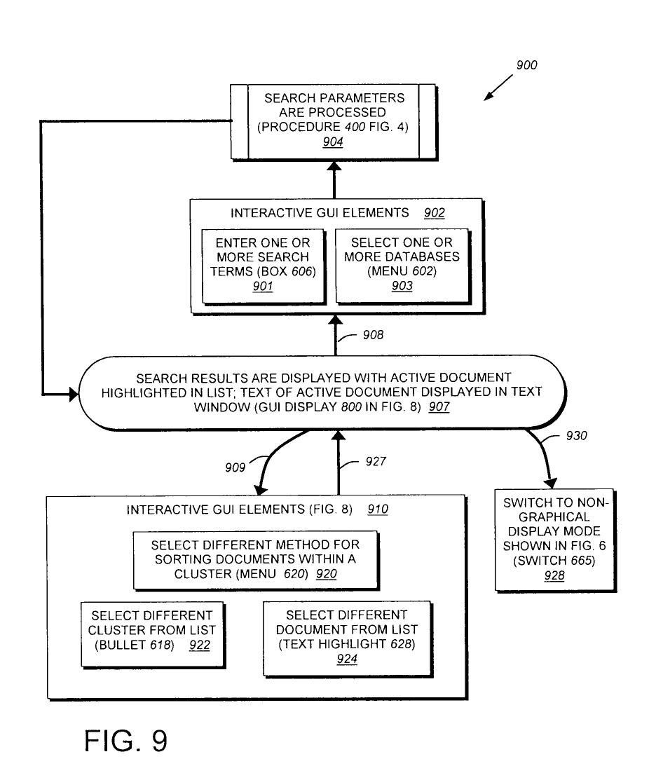

Following the generic search engine process 146, the DD Server 106 sends the search results 147 to the Client 104 via the network connections represented by the Internet 102 in this example. Once the search results 147 are received by the Client 104, the Client initiates the process 400 to generate a sorted list of document clusters (described below in FIG. 4 and FIG. 5). Upon the creation of the sorted list of document clusters, the end user interacts with the search results on the Client 104 via the process 600 to display and navigate search results 600 (described below in FIG. 6, FIG. 7, FIG. 8, and FIG. 9).

In an alternate embodiment that is not shown, the end user may conduct a search using a Client 104 in the absence of a locally installed copy of the DCI. Examples of this include computing devices with insufficient memory to store a complete copy of the DCI, or an internet-based search from a Client that is a public computer. Under these circumstances, the DCI File Server 132 may provide the Client 104 remote access to DCI (copy 1) 130 via the network connections generally referred to as the Internet 134. It is contemplated that the Client 104 access DCI (copy 1) 130 automatically when the Client 104 attempts to run the process 400 to generate a sorted list of document clusters in the absence of a resident DCI (copy 3) 142. Note that a distributed DCI, as described generally above, may also be employed among a group of clients.

With reference to FIG. 2, a block diagram illustrating the data structure of a DCI 108, and how it is derived from the DD 114 using the Index Generator 118. Referring also to FIG. 3, a procedure 300 by which the DCI 108 is generated from the DD 114 using the index generator 118 is shown. Note that the database(s) herein is/are typically implemented on the server based upon the well-known Windows® NT operating system, using a conventional software package such as SQLServer 7.0, both available from Microsoft Corporation of Redmond, Wash. Other commercially available operating systems and databases can be substituted in the server according to alternate embodiments.

FIG. 2 particularly illustrates the data structures created by the system 200 in which the documents (FIG. 1) 116 contained in DD (copy 1) (FIG. 1) 120 are examined by the Index Generator (FIG. 1) 118 and the resulting Entries (FIG. 1) 109 are recorded in the DCI (FIG. 1) 108. DD (copy 1) 120 is generally defined as a set of distinct text (possibly containing images) documents that are grouped together based on shared defining characteristic(s) of their contents. For the purposes of this example, DD (copy 1) 120 is shown containing six documents 202, 204, 206, 208, 210, and 212. In practice, the DD can contain thousands, or even millions, of separate text documents. Moreover, while the analysis of a single document is shown for the purposes of this example, the Index Generator 118 may process multiple documents and multiple databases simultaneously. In this illustration, documents 202, 204, 206, 208, 210, and 212 each have a title and a text body (as shown), with both the title and text body containing text patterns that can be used for identifying and referencing items in the database. A variety of techniques can be employed for establishing a document's title. The title can be established from an appropriate database field recognized as the “Title” or it can consist of an Author name or the first several words in the text body. A similar naming structure is found in word processing systems, wherein a portion of the text may assigned as the document's file name or “title.” In general, it is contemplated that the mechanism for identifying and referencing database contents may include well-established pre-existing conventions (IP addresses, URL's, bibliographies, legal citations, etc.). In an alternate embodiment, database-specific conventions for identifying and referencing documents may be created using similarities in document content, such as database-specific vocabulary, proper nouns, etc. In either embodiment, the convention specified for the database is reduced to a generalized text pattern to be used as a template for text-pattern comparison. Of course, variations on this arrangement, which use well-known methods for identifying and extracting information according to pre-defined text patterns, are also contemplated.

Starting with the title 213 of a selected document 206 (having text body 215), the Index Generator 118 uses a generalized text pattern template to identify the extracted title (in this example) as the document's unique identifier (214). Once a unique identifier is extracted, the Index Generator 118 parses the identifier 214 into pre-defined text pattern component elements 215, 217 and 219, creating an Index Handle 216 for the document 206. For each unique Index Handle 216, an entry is recorded in the DCI 108 based on the taxonomy of the Index Handle components identified as Aᵢ, Bⱼ and Cₖ (215, 217 and 219, respectively). For example, in the case of a legal citation, Aᵢ, can be a case title (e.g. “Smith v. Jones”), Bⱼ can be the reporter citation (e.g. 198 F.5^{th} 221), and Cₖ.can be the Court/date in which the decision was made (e.g. 13^{th} Cir. 2012). The actual parsing and number of components is highly variable.

Using the process 300 to generate a DCI 108 from DD (copy 1) 108 (described below in FIG. 3), the Index Generator 118 examines the document 206 text-body, extracts the Incoming Index Handle 221 and Outgoing Index Handle 223 references for the subject document 206, and records the extracted Index Handles in the DCI 108. For the purposes of this example, six Index Handle entries 222, 224, 226, 228, 230, and 232 are shown in the DCI 108 with multiple incoming and outgoing links. In practice, hundreds of thousands of DCI Index Handle entries may exist. Furthermore, while each Index Handle is shown with the same number of incoming and outgoing links, the number of incoming and outgoing links associated with each Index Handle will generally differ. Moreover, in general most Index Handles will have only one or two incoming and outgoing links, while a few Index Handles may have thousands of incoming and outgoing links. Generally, the DCI 108 will only contain Index Handles for the set of documents native to the DD 120, however it is possible Index Handles from separate, but related, databases may occur, making it necessary for the Index Generator 118 to identify text pattern templates for both subject database and related database Index Handles. For example, systems for uniform citation often use a standardized format that assigns similar document citations to similar yet distinct collections of documents. It is contemplated that methods for reducing duplicate or erroneous DCI entries may include determining the probability of a match between the template and the extracted Index Handles and determining the probability two Index Handles are the same.

Based upon the acquired Index Handles, 222, 224, 226, 228, 230 and 232, for each document in the DD, the system now builds new entries into the DCI by taking the parsed portions of the handle and establishing links between other documents. Reference is made to the procedure 300, as shown generally in FIG. 3, which generates entries in the DCI using the Index Generator 118. The Index Generator 118 first pulls a document from copy 1 of the DD 120 (step 310). The procedure 300 then queries (decision step 312) whether the document already exists in the DCI, comparing with the present version of the DCI 108—denoted as incomplete, as new entries have not yet been built. The Index Generator 118 may continuously scan for new documents by reviewing the entire DD and performing the procedure 300 on each document, in turn, or it can scan for changed/new documents that have flags indicating that such documents have not yet been indexed or required that the index be updated for new information. The procedure 300 then extracts references to other documents contained within the DCI from the text body of the newly scanned document (step 316).

Any located text entries within the text body of the scanned document are now added to the outgoing links for the DCI entry of the document as outgoing links for that document. The procedure next queries (decision step 320) whether a located reference within the scanned document's text body is provided within the DCI. If it is not, then the procedure 300 creates a DCI entry for the new reference (step 322). The procedure 300 then adds the newly scanned document's Index Handle to the DCI entry of the referenced document as an incoming link 324. Steps 318, 320, 322 and 324 repeat for all references located in a given scanned document text body.

Once all references have for a current scanned document have been handled, the procedure continues to step 326, wherein the scanned document is removed from copy 1 of the DD. This step presumed that the DD copy 1 (120) includes all documents, including new ones, or only update, and is designed as a working copy, derived from the main DD 114. In alternate embodiments, the document is not removed, but a flag is set in the document indicating that it has been fully acted upon.

The procedure 300 then queries (decision step 328) whether any documents still remain to be scanned in copy 1 of the DD 120. If so, then the procedure fetches the next document from the DD 120. The procedure then scans the next document's text body and builds appropriate outgoing links for its entry and incoming links for the references located within its text body. Once all documents have been scanned, the DCI 108 is now complete and updated (procedure branch 330).

Referring again to FIG. 2, the DCI entry for the exemplary document 206 includes the relationships between each referenced documents' Index Handles. At least one parsed component Aᵢ, Bⱼ and Cₖ is held in common between each reference and the subject document Index Handle. In the case in which an entry does not contain at least one common, parsed component, then the entry is typically a reference to a document in a different (but related) database. Notably, the system of this invention can be adapted to track the occurrence of such entries. This information can be used to gauge the efficiency of the pre-existing database architecture. In other words, where a plurality of such entries occur, it may imply that the documents are inefficiently contained across two or more databases when they should be part of the same database. Appropriate corrections to the database to include both documents can be made based upon this data.

Referring now to FIG. 4, the procedure 400 for generating a sorted list of document clusters that is carried out within the client 104 is now described in further detail. Note that the tasks described herein can be distributed in any manner. For example, a remote server can carry out the process, and deliver the results to a client browser. In the illustrative embodiment, and as defined by respective dashed boxes, the procedure is divided into the client task 410, Network/Internet task 412 and DD Server task 414. On the client side, the end user initially enters search criteria (step 420). This can be defined by a Boolean search term, or another form of advanced searching. The network (412) then transfers the search criteria to the DD Server 106 (step 422). On the DD Server side 414, the search criteria are processed by the DD Server 106 for matching search criteria (step 424) to those entered by the end user. The DD Server then compiles any Index Handle that corresponds to the search terms (step 426). The results are placed into a list of associated documents. This list of Index Handles is transmitted over the network/Internet (step 428). The list is received by the client. The client looks up the outgoing links for the Index Handles in the entries listed in the DCI (either resident or accessed from a server) in step 430.

If a document appears in an outgoing link list and in the search result list, then the procedure 400 associates that document with the document whose outgoing link list contained it (step 432). The procedure then defines a document cluster for each group of associated documents. The number of documents in each cluster is counted and displayed (step 434). The list of document clusters is sorted from largest cluster to smallest cluster in the illustrative embodiment (step 436).

In step 438 the result of the procedure 400 is displayed to the client as a sorted list 440 of document clusters 442, 444 and 446. The number of document clusters and relative size of each cluster (in number of included documents) is highly variable.

The step (438) of creating a sorted list of document clusters (also termed the SLDC process) is shown by way of example in FIG. 5. In particular, this illustration details a state diagram showing a simple, exemplary case of the process by which a sorted list of document clusters is generated from a list of search results 510 revealing Documents A-J and a version of the DCI 512. The DCI entries are shown as Documents A-J, with corresponding outgoing links 520-529, respectively. The exemplary outgoing links display connections between the searched Documents A-J and respective documents in the DCI (including others not in the search results, such as K, L, M and N). As described above, these outgoing links are chosen based upon the relationships between the text bodies of each document's text bodies and Index Handles of other documents. In this exemplary procedure, the outgoing link 521 of Document B is acted upon in step 1 (box 530). The list 532 containing a straight listing of discrete documents is updated to become new list 534 where Document D is now linked with Document B. This updated list 534 is then further sorted in step 2 (box 540), based upon the outgoing link 522 for Document C. That is, Document A is now linked to Document C to generate further sorted list 544. Then, using the outgoing link 524 for Document E, step 3 (box 550) entails linking Document G to Document E to create further sorted list 554. Now, the list 554 is further sorted in step 4 (box 560) to generate further sorted list 564. In this list Documents E and G have been linked with Document F. Again, sorted list 564 is acted upon in step 5 (box 570) to create sorted list 574 in which Document H is also associated with Documents G (which has already been associated with Document F—along with Document E). At this point, all documents have been associated with a respective cluster, based upon outgoing links. These clusters have differing sizes ranging from four documents to one document (in the case of I and J, there are no links). The clusters are sorted according to size in step 6 (box 580), generating clusters 581, 582, 583, 584 and 585 in descending order. The sorted list 590 can now be presented to the user with each discrete cluster 581-585 placed in a discrete identified cluster (Clusters 1-6; 591-595, respectively). These clusters can now be delivered to the end user for review.

It should be clear to those of ordinary skill that the sorting procedure described above can be varied from that shown. More advanced sorting techniques that involve multiple sorting threads and/or parallel processes may be advantageous particularly where a large volume of documents are to be sorted.

Note that non-linked documents (K-N are not provided in the search) according to this embodiment. The ordering of results based upon mutual connections and the omission of results that are not connected follows the network theory offered by Professor Albert-Laszlo Barabasi the university of Notre Dame and as described in Linked-The New Science of Networks, by Albert-Laszlo Barabasi, Perseus Publishing, Cambridge, Mass., 2002. In Linked, professor Barabasi offers proofs that the elements in networks (both manmade and natural) often exhibit strong characteristics of mutual connectivity. As such, it would follow that ordering clusters so as to place searched documents displaying the highest degree of linkage at the highest ranking, while placing unlinked, or minimally linked documents at a lower ranking—or omitting them completely from the list. It is believed, based upon this theory, that for any input search terms, the most linked documents provide the most valuable results-particularly in terms of the relevance of the searched results to the search terms.

More particularly, complex web like structures have been shown to be a persistent theme in the organization of a wide variety of systems. By way of background, traditionally complex networks previously fell under graph theory; and since the 1950s large scale networks with no apparent design principles have been described as Random Graphs. Mathematics describing Random Graphs was first studied by Paul Erdos and Alfred Renyi, who provided us the mathematics behind traditional statistical mechanics. Such traditional statistical mechanics describe the bell curve—a bell curve being the distribution of possible number of links any given node has. This occurs because in Random Graphs the probability that any two nodes will connect to each other is purely random. Hence, academics began to query whether the real networks behind the World Wide Web and cellular metabolic structures were fundamentally random.

Over the last decade four factors contributed to the realization that real networks were not fundamentally random. These factors are: (1) computerization of data acquisition in all fields led to the emergence of large databases on the topology of various real networks; (2) increased computing power allowed the manipulation of million of data points present in real networks; (3) breakdown of boundaries between scientific disciplines offered access to diverse database enabling scientists to uncover the generic properties of complex networks; and (4) a need to understand the behavior of the system as a whole. Unlike the distribution of links in a random graph, the link distribution in real networks is a Power Law. This realization, hence, required the creation of a new field of mathematics to describe the statistical mechanics of real networks. The goal of this new field was to differentiate between Random Graph Theory and real or scale-free Network Theory. Part of that difference stems from the fact that Random Graph Theory intends to construct a graph with correct topographical features while Network Theory attempts to capture network dynamics, i.e., “If one captures correctly the processes that assembled networks that are in use today, then one will obtain their topology correctly as well.”

It is recognized that, in Network Theory dynamics takes the driving role, with topology being a byproduct of this modeling philosophy. In Real Networks—two major components to their dynamics first addressed in 1999 are (1) Growth and (2) Preferential Attachment. Growth is when a new is node added to database. In the illustrative embodiment nodes are equivalent to documents with every node entering the system with at least one link. Preferential Attachment relates to the probability that one node will link to another node, which depends on how many links the subject node already has; i.e., nodes are more likely to link to nodes that are highly connected. How many links the subject node has is dependent on: (i) when the node entered in the system; i.e., the longer in, the more likely something will link to it—“early adopter” bonus and (ii) how fit a node is as perceived by other nodes; i.e., each time a node links to another, the creator of the link has made a decision that the subject node was better than any other node.

In the case of Directed Networks, i.e. networks such as the World Wide Web (as opposed to the Internet, itself) where links connect in one direction, not both, the results of directed network include a Fragmented Cluster Structure, where the clusters are not unique but depend on the starting point of the inquiry. In particular, there are cases in which everything is connected in one group of highly interconnected nodes, but is fragmentary for nodes with only incoming and outgoing links—at the network edges. To this end, the more specialized the inquiry the more likely the cluster containing the info will be located in the fragmentary edges i.e., from a distance every part of a tree is connected to the whole, but from up close one leaf does not connect to another leaf. Also two different power law distributions are present—Incoming vs. Outgoing. An Incoming power law distribution is passive, unchanged as size of network increases because it means the overall fitness of a node with relationship to the network as a whole; how much of the network resources are controlled. An Outgoing power law distribution is active, with a higher γ than incoming distribution. The distribution represents how fit every other node in the network is as determined by the subject node. A higher γ than incoming distribution means a steeper curve—which means the addition of an outgoing link to any one node is more likely to impact the probability fitness future outgoing links will originate from that node. Incoming distribution shows the importance of a node to network; outgoing shows the importance of one node to another; i.e., a node specific assessment of every other node.

Generally an Incoming distribution starts at network center, generalizing outwards. An Outgoing distribution starts at network edges and determines how specialized the information is. When γ outgoing is significantly higher than y incoming this indicates that outgoing links are generally more important. All links are created as Outgoing links, and a node cannot create an incoming link. Most importantly generalized/fittest nodes will generally have far more incoming links than outgoing links.

In accordance with the inventive concepts described herein, outgoing links are created based on how important the recipient node is to the subject node; i.e., how relevant is the recipient to a given document. Incoming links show how relevant a document is to the body of knowledge it is related to. The generative process for creating links is that every link is created as an outgoing link, and the process that assembled the network is oriented from the outgoing links. To this end outgoing links assembled by the network are created by fitness assessment that subject node is better to link to than other nodes. This fitness assessment can be called relevance. Therefore, outgoing links provide the relevance of one document to another. Incoming links provide relevance of a document to every other document.

A sorting function in the inventive system and method employs outgoing links to assemble clusters of documents. The document cluster contains documents or a body of knowledge or a concept. The size of a cluster determines how generalized or specialized the concept is. Each cluster represents a different body of knowledge that fits search criteria; therefore, if a node in the cluster with more than a critical number of outgoing links is irrelevant, than all documents in the cluster are irrelevant. Also, if cluster size is correlated to probability, desired search results will be contained in cluster; i.e., the bigger the cluster, the more likely the cluster contains the desired information. Cluster size also determines how relevant the concept is to each document; i.e., the bigger a cluster's diameter, the more generalized the body of knowledge, the less relevant each outgoing link.

In this manner the inventive system and method is better than traditional search algorithms, which typically employ a top-down approach to search results. Such traditional results are: (i) composed of a few steps; (ii) only locate documents that match search term; (iii) compare results against each other; (iv) assign each result a score based on the relationship of the results to the network as a whole; (v) give each result a score based on the relationship of the results to all other results; (vi) sort the results by combined score; and (vii) at every step along in the algorithm process, relevance of any given node is determined as compared to every other node; i.e., a node's relevance is the aggregate of how relevant every other node indicates the subject document is.

The disadvantages of this traditional approach are that relevance is based on comparison to network as a whole with respect to incoming links. Also, the generative process that assembled the network is based on assessing relevance of one node to another—i.e., outgoing links. Experimental data indicates that these two approaches are not equivalent and demonstrates that creation of an outgoing link is more likely to change a document's fitness than an incoming link because outgoing links require a relevance assessment. A Directed Network approach implies that the World Wide Web is highly connected towards center, becoming increasingly fragmented towards edges; thus: (i) using incoming links to generate clusters will cause generalities to rise to the top and specialization to be suppressed; and (b) using incoming links to generate clusters will cause fragmentation of results into clusters; with clusters initially differentiated by different bodies of knowledge relevant to the search and with specialization of the knowledge determined by cluster size. Moreover, search algorithms using aspects of the network topology fragment similar search results when returning the list of search results because: (i) the list is sorted by relevance of document as compared to that of the entire network and the associated relevance of all other search results; (ii) the most relevant documents would probably come from the largest cluster; therefore, so will any other documents' top results; (iii) other relevant documents not from the same cluster will wind up scattered throughout the results; (iv) fragmentation of concepts is caused by sorting results based on the entire network, rather than on each result's neighbor; and (v) fragmentation of concepts only gets worse as network grows because of specialization.

The inventive system and method of this invention addresses the above-stated problems in that fragmentation at edges of a Directed Network occurs because creation of outgoing links involves an assessment that the target node is relevant based on the target node's fitness relative to how the subject node perceives the fitness of all other documents. The greater the number of outgoing links a node has, the higher the probability the node will form more outgoing links, and the less relevant each outgoing link is to the entirety of the fitness criteria, which the node uses to create new outgoing links. Whereas the smaller the number of outgoing links a node has, the lower the probability the node will form more outgoing links. Hence, the target node must be fundamentally relevant to the criteria used to determine fitness. Thus, the first few outgoing links can dramatically change node's location in the network. The probability any two outgoing links connect to nodes that are relevant to each other decreases as the number of outgoing links a node therefore increases. In general, the choice of each additional fitness criteria reflects the purpose a node serves in the topology of the Directed Network.

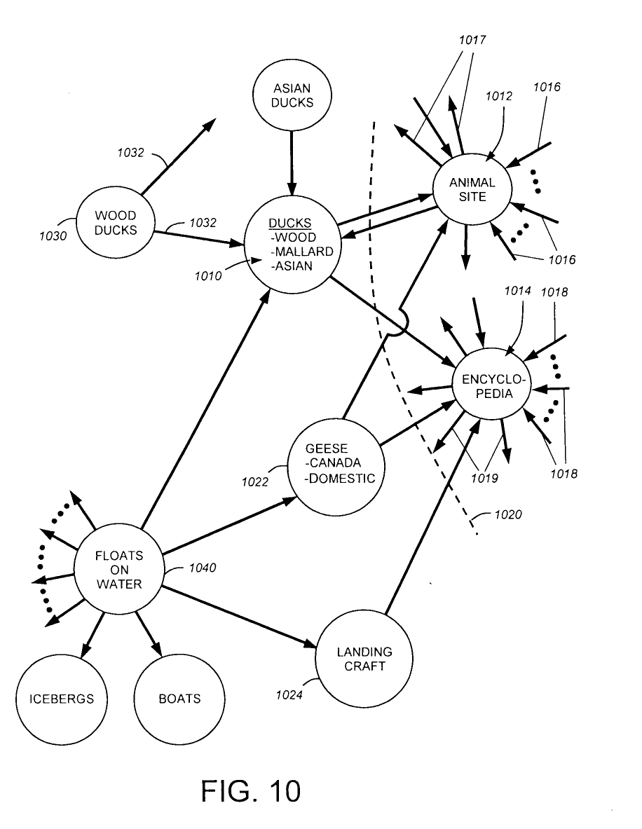

An example of the general proposition of the inverse relation of the number outgoing links to the relevance of a given node to a search cluster is illustrated by way of example in FIG. 10, which breathes new life into the old adage that “if it looks like a duck, quacks like a duck, then it is a duck.” In this example, the searcher desires information on “ducks,” particularly aquatic birds of this classification. In retrieving search results, the searcher obtains a cluster of documents 1010 that are particularly classified as related to the birds, ducks. These documents include information on various types of ducks, including wood ducks, mallards and Asian ducks. The cluster points to a pair of generalized sites, one regarding animals (1012) and one which is a general encyclopedia (1014). A large number of respective incoming links 1016 and 1018 also point to these sites, representing a large number of unrelated topics. Due to this large number of unrelated incoming links, it is less likely these sites will provide the type of truly pointed search results that our user may desire and the search application of this embodiment can filter (dashed line 1020) out these general authorities based on the number of unrelated incoming links. Note there are a large number of outgoing links 1017 and 1019 in these general sites 1012, 1014, including those to the relevant cluster 1010.

In the example of FIG. 10, the search for ducks may also retrieve sites on geese 1022 as well as those on World War II landing craft (1024) commonly termed “ducks.” Notably, each cluster 1010, 1022 and 1024 is pointed to by a number of nodes having outgoing links, at least one of which is pointed toward the cluster. Under the rules of the illustrative search procedure, the relevance of a node with a link into a cluster is determined by the number of outgoing links it possesses. For example, a node related to wood ducks 1030 has only two outgoing links 1032, including one to the cluster 1010. This site would tend to be highly specialized and relevant to at least some of the topics related to the birds, ducks. A searcher would likely wish to include this in his or her results. Conversely, a node 1040 with a link to the duck cluster 1010 is also connected to the geese cluster 1022 by outgoing links as well as the landing craft cluster 1024. This node is generally about things that float on water and contains many unrelated outgoing links to such topics as boats 1042, icebergs 1044 and the like. In a network topology, this node 1040 would be somewhat distant form the cluster 1010 of interest. This nodes (1041) large number of outgoing links can, thus, be used as the basis for omitting this search result and those it links to. In this manner, outgoing links form a basis for selecting the diameter of a search and focusing results on a group of nodes that are most relevant to, and directed to, the desired search topic. To this end, setting a large search diameter will retrieve geese and landing craft, while a smaller diameter will naturally tend to yield sites particularly focused on mallards, geese, and the like. When compared with a general text search on a well-known Web site, the results for each topic will appear in no particular order. There is no technique in such search methodologies to set the diameter per se.

Thus, in the Directed Network, nodes can be characterized as differing types. For example, a core with highly interconnected nodes can exist these nodes tend to form a core cluster of relevant documents. Nodes also exist that the core connects to (via and incoming link to that node) but that do not connect back to the core, and also exhibit a large number of incoming links. These nodes (e.g. sites of general interest) are needed for overall network structure and influence the network-wide topology. Such nodes will be relevant to a wide variety of searches but have a low probability of helping to further define the desired subject.

Likewise there will exist nodes that connect to the core via an outgoing link form the node, but that the core does not connect back to. Such a node can be a newly added node (via the procedures described above) as every new node will have at least one outgoing link. The node may also be one with more than one outgoing link that the other nodes are nodes are not interested in linking to. It is these types of nodes that cause fragmentation at the edges of the network.

In general, a core set of nodes that define a concept tend to link to each other, and new links tend to join two nodes in the cluster; i.e., these nodes probably will be internal to the concept. However, new links from nodes outside the cluster are probably from nodes with relatively few outgoing links—in which core cluster's concept is highly relevant. Fundamentally, outgoing links from the cluster connect the specialized concept to the generalized concept it is based on and to other specialized concepts to which it is related.

Thus, this inventive system and method uses the indexing (the DCI), correlating (comparing) and sorting (see generally procedure in FIG. 5) search results based on each node's outgoing links. As discussed, this technique generally eliminates the characteristic fragmentation of concepts matching search criteria that is experienced in conventional key-word search techniques. In this manner, the system effectively eliminates all nodes in a returned cluster if one of the core nodes in that cluster does not match the desired concept. The search procedure of this invention, in fact, follows the process that assembles the overall network of search concepts—as such, variations in localized network topology do not impact the chances of finding a desired concept. Moreover, the process of indexing outgoing links for each node defines how specialized or generalized a node is with regard to the concepts to which it is relevant. As discussed, the greater number of outgoing links generated by the index, the less directly relevant a concept will be. In this manner unwanted results are quite effectively suppressed, in opposition to conventional search engines, which may return millions of variously relevant results in no particular order.

Also, fragmentation at the edges common in conventional search techniques often causes related concepts to appear unrelated, while clustering search results by outgoing links shows the set of concepts related to a set of search criteria, including both unanticipated and anticipated concepts. The receipt of unanticipated links or results depends, in part on the system's error tolerance, which can be particularly defined by changing the search radius. Additionally, of significance is the fact that the inventive system and method is relatively unaffected by network/database size. That is, the size of the database, and number of results returned does not affect searches because clustering outgoing links incorporates scale-free properties of network

With reference again to FIG. 4, it is contemplated that the procedure for establishing clusters 438 may account for the number of times given documents are cited in other documents to provided further weighting to the ranking of clusters. For example, a document which is cited three times in three linked documents can be given a higher ranking that a document which is cited only once in each of three linked documents.

Naturally, providing clusters of linked documents may result is a massive return of information, making the task of culling information from clustered documents a daunting or impossible task. Hence, FIG. 6 details a novel GUI 600 with which the end user can better organize and review search results in accordance with an illustrative embodiment of this invention. It is contemplated that the various novel functions and the novel layout of information presented herein can be implemented using conventional programming languages and techniques within the knowledge of those of ordinary skill. The depicted GUI screen 600 is presented when the end user selects the graphical display mode, as indicated by legend 601. The user selects the database or databases in which he or she wishes to search using the database button 602. This button presents a menu (not shown) of available databases and/or allows the user to navigate to Internet/public databases, where these public sources can be served by the Index Generator and other network components. A list of accessed databases in this example is provided in Database box 604. The listed databases are those in which the search terms will be applied. These search terms are entered by the user in box 606. The exemplary arrangement for providing search terms is a simple text entry (typically with Boolean operators). In alternate embodiments, the GUI can offer the user various forms of advanced searching capabilities. For example, in the case of legal citation searching, the user may be able to select a box that allows him or her to separately enter certain relevant data (e.g. Court, year, judge, district, plaintiff, defendant, etc.) in specific windows, and click a search command after entering information these specific data fields. In this embodiment, the search is initiated using a Search button 608.

The search follows the procedures outlined in FIGS. 2-5 using the exemplary network arrangement shown in FIG. 1 to return clusters that are listed in the Cluster List pane 610. In this example, the search returns five discrete clusters of documents (Cluster 1-Cluster 5). Each cluster is identified by a respective icon or bullet 612, 614, 616 and 618 (or by another graphical symbolism) having a color or pattern that indicates a ranking of clusters. In this example, Cluster 1 has a discrete pattern with 4 linked documents; Clusters 2 and 3 are discretely patterned and contain the same two documents, each with two documents, and Cluster 4 and Cluster 5 each having one document. Each cluster can be clicked upon to reveal its individual list of documents. In this case, the user is provided with a drop-down window 620, that allows sorting of clusters by a number of parameters. As shown, the user is sorting by number of incoming links. The vital statistics on the located clusters can be displayed in a Cluster Size histogram window 622, shown herein beneath the pane 610. Clusters are displayed in numbers of clusters within certain predetermined ranges of document-counts. In this example, the histogram indicates one Cluster having 3-5 documents and four clusters having 1-2 documents. This information can be displayed graphically, or according to another type of numerical arrangement in alternate embodiments. It provides the user with information as to the relative scale of the search results and the relative size of each cluster.

Where a large number of clusters or individual lines of information are provided, the pane includes a scrolling bar 624 that allows vertical scrolling through the list. As shown, each cluster can be clicked upon to reveal individual documents. In this example, Cluster 1 has been expanded to provide its full listing of documents. Each document is appended with a field 630 showing its incoming (and/or outgoing) links.

Notably, by clicking on the document to highlight it (highlighting 628), that document becomes the central item within the cluster graphic display window 626. In this example, Document G has been highlighted (628) by the end user, or has been highlighted by default as the highest ranking/relevance document in the first cluster with the most displayed links 630 (5 links in this example). As such, the center of the graphic display window's (626) field of view contains exemplary Document G with its unique colored/patterned bullet or icon 632. In this manner, the user can quickly identify the document, which also includes a legend 633 identifying it as Document G. Notably, every other document that is part of the cluster with Document G (e.g. Documents E, H and F) is also displayed with the same color/pattern bullet or icon 632. Each document is identified by a corresponding legend 633. These documents, thus define nodes in a network of related documents. The relations are defined by the unique colors/patterns of the bullets or icons, and the relationships between the nodes are defined by link arrows 634 between nodes. Intuitively, an arrow from a first document, to a second document indicates an incoming link to the second document from the first, and vice versa. An arrow 634 with a closed point represents an on-screen link, while an arrow with open point 636 represents a link to an off-screen node.

Further documents from different clusters are also displayed in the window 626. For example node bullets/icons for Cluster 4 (638) and Cluster 5 (640) are displayed with their corresponding connections. In this example, the graphic also displays non-search result notes (642) for Documents N, X, Y and Z. Any of these notes can be filtered out using, for example, the Hide button 650 allows the user to hide any nodes that are not in the selected cluster. Likewise, the user can hide documents that are linked but not in the database(s) being searched. In this manner, the user can better control relevance where the search results are likely to occur only in the selected database(s). The user can also select whether to hide documents based upon a minimum number of links. This parameter is defined via a selection box 654.

A convenient feature of the GUI is pop-up textbox 646 with additional document information. This box is exposed by applying the cursor 644 (or another interface element) to the selected node (Document I) in this example. The box 646 includes a thumbnail description of the document including its name and date 641, cluster 643, source database 645, relevance to the search 647 (defined as a score based upon the amount of search term information matching text in the document), number of incoming and outgoing links 649, and a brief fragment of text 651 surrounding each search term. Two other useful features allow the user to define the “diameter” of the search and the field of view of the window 626. The diameter is set using a setting box 653 that allows the user to specify the maximum number of node links to display. In other words if a Document 1 is linked to Document 2; Document 2 is linked to Document 3; and Document 3 is linked to Document 4 (and they are not interlinked, such as Document 1 to Document 4), then by setting the diameter at three nodes, Document 4 is filtered out. Likewise, the zoom bar 648 allows the field of nodes displayed to be expanded or contracted. It is contemplated that a wide, zoomed-out field with many nodes can be re-centered by clicking in the region of interest and then zoomed in again to attain a readable view of a remote area of the network.

Notably, the GUI 600 also contains a document text box 656 below the graphical box 626. This box contains a legend 658 identifying the document, which is the subject document of the node. The interior of the box 656 contains the text 657 of the document, which can be displayed either from the start of the document or from a location within the text body containing the search terms. In either case, the search terms can be highlighted. A different document can be called up in the box 656 by clicking on that document within the cluster window 610 (which also re-centers the graphic) or by double-clicking (or taking a different action) upon a displayed node. The text of the document can be scrolled-through using the scroll bar 660 or another mechanism. In a related embodiment, the document can be placed into a different pane for fuller viewing. Likewise, as discussed below, the entire window 626 can be placed into textual mode (and back to graphical mode when desired) by toggling the mode switch 665. The box 656 also contains a Save button 662 that allows the document to be saved to a file on the computer. An appropriate file system box may be called to locate a folder or drive for saving the document, or a default location may already be in place, eliminating the need for a separate box. Likewise, a Print button 664 sends the document to the printer in a conventional manner. The user may also print the node display 626 using appropriate print buttons (not shown) or conventional print-screen tabs.

Having described the layout of the exemplary GUI of this embodiment a discussion of its desirability and advantages is now provided. In general, the challenge for a GUI is to organize search results and display them in a meaningful way. Currently, search engines return results in the same way as early databases did 25 years ago—as a text list. The text list is further broken up by the number of results per page because most searches tend to find at least one relevant document within the first few pages. This approach saves bandwidth because the user need not call up screen-after-screen to retrieve all results. As discussed above, fragmentation of concepts within search result list means having more than one page at a time has little or no benefit, since more results will not reassemble clusters. It is noted that data and indices are stored in text, a search query is given in text, and the central processing unit of the search engine searches and returns text results—thus, results are invariably displayed in text. Also, the act of querying a database was created when computers had little or no graphics capability. Where information is to be displayed in clusters, however, a text list is usually not best way to display these clusters. This is because the use of outgoing links to determine relevance assembles concept clusters as results rather than as a list of individual hits; i.e., data is organized differently. In general, sorted lists of text make individual results harder to distinguish; i.e., finding data is more cumbersome. Also, while text makes data storage possible, humans are not designed to process large amounts of text, particularly those that may be highly repetitive in content. Rather, computers excel at this type of processing.

In fact, humans are hardwired for abstract pattern recognition. In order to make sense of their environment, humans group items by similarities, enabling us to generalize patterns. We can use these generalized patterns to assess the state of our environment and to plan our actions accordingly—this comports with the above-referenced parable, “if it looks like a duck, and it quacks like a duck, it's a duck.” To this end, the generalized pattern for defining a duck based on major features of all ducks: i.e. color, plumage, distinguishing features left out of pattern so that even though no two ducks are the sane, we are not surprised that a Mallard and Wood Duck are both ducks, just as no two Mallards act the same.

This is beneficial to an understanding of environment because generalized pattern of a duck includes it is highly unlikely a duck or group of ducks will try to eat the observer, that ducks are edible, and that if a pattern more-relevant to the observer's wants or needs appear in his or her environment; (for example, a wolf), then the observer can lower the priority of ducks in order to respond to a new development.

The ability to abstract a pattern is lost where a human user is overwhelmed by repetitive information that is seemingly indistinguishable (e.g. losing the forest for the trees). Moreover, end users lose the ability to perceive abstract patterns for differentiating results mainly because text lists employ a generalized format for displaying each search result (for example Google's standard format). This format lulls the user into thinking that all results occurring within the format are actually indistinguishable. The user may actually be surprised (i.e. do a “double take”) when he or she comes across a different result within the overall presentation of formatted text results. But, use of text lists also requires that users digest such numerous repetitive results before the information storage pattern can be abstracted. Hence there is a conflict between the numbing effect of a standard format, which causes the user to generalizes, versus the need to see many results before the generalization can occur.

A human's capability for abstract pattern recognition enables one to integrate large amounts of environmental data into our decision-making process and improves the observer's chances of success. The illustrative node-and-link configuration in the GUI of this invention is a common pattern in nature that renders pattern formation intuitively obvious for the end user. For example, this pattern is present in trees-nodes are the points where the tree divides itself, i.e., the point where two branches insect. Links can be compared to the part of the tree that connects two juncture points; i.e., a branch after it diverges from the rest of the tree but before it diverges into more than one branch. The illustrative node-and-link configuration affords a natural pattern for displaying search results in a form that is readily comprehended by a human user.

Traditionally, people search the World Wide Web by navigating to web pages that seem to fit the concept, in whole or in part, based on a brief text description of contents. Once a webpage containing a concept that generally fits is found, the person then navigates from page to page using each page's outgoing links until the desired information is found. With practice, the user can learn how to adjust the parameters of a search so that a document or the desired subject/concept can be found near the top of the list on the first page of results, but the end user still must navigate from website to website.

Search terms input by a user describe the properties of the generalized concept—i.e., find documents that look like a duck and quack like a duck. Each cluster is the equivalent of a concept that matches the properties of the generalized concept. The following are determined by concept properties. In this example, each cluster could be a species of duck. The largest cluster could be about all things related to ducks, while another cluster could be related to the above-described WWII landing craft.

The illustrative embodiment uses outgoing links to construct the various concept clusters related to a set of search criteria. Clusters are sorted by size because the larger the cluster the more generalized the concept—therefore, the more likely it will contain the desired concept. Thus, it is better to display larger clusters first. In practical terms, concept clusters enable the end user to discard an entire cluster if the end user determines certain documents within the cluster are irrelevant; i.e., if a document central to the concept is irrelevant then the cluster is irrelevant, and all documents in cluster can be thrown out, thereby suppressing large amounts of redundant information. For example, two million text documents are replaced with five main clusters on a GUI screen, and these clusters are oriented on the screen in a manner best suited to the processing capabilities of a human user.

The fragmented structure of a Directed Network implies the separation of concepts based on outgoing link selection. This arrangement should be an integral part of the illustrative GUI. The GUI requires elements that allow the user to tailor the display for each search and to quickly evaluate concept cluster relevance. One element is the display of each cluster in the GUI main window. The GUI also includes basic settings that adjust display for each search and settings that affect cluster generation. The GUI allows for the entry and display of search terms and the applicable database—defined as a collection of documents stored either centrally or distributed over a network. This enables the use of a display on generalized data sets or presorted data sets. The GUI also supports settings that change the display of clusters.

The GUI should also allow the user or another mechanism to define the cluster diameter—this allows the user to split large, generalized concept clusters into component concept clusters without altering the search terms. The simplification of cluster display is also desirable. This provides the capability of suppressing nodes for the purpose of reducing clutter within the search results, and hence, allows the user to better investigate the structure of the cluster.

The GUI should further allow the display of information that enables the user to quickly determine which concept cluster is the closest match to the intended concept. It should include a mechanism of quickly selecting different clusters. Clusters are listed by size and documents in a cluster matching search results sorted by relevant parameters—this helps the user to find key cluster documents. In this arrangement, incoming links are sorted by a node's relevance to entire database and outgoing links are sorted by a node's relevance to entire cluster. Moreover, when determining relevance, the content of an individual document is less important to the search than how it connects to a concept cluster. When an individual document is determined important, the GUI advantageously provides a mechanism for quickly ascertaining a node's relevant search results without browsing to the website using, for example, a hovering popup. In addition, the GUI provides a mechanism for quickly reviewing the body of a selected document without navigating. A document text box is provided and contains body of document.

The GUI's node selection function shows the document body, enabling user to better determine whether or not the concept being displayed is the desired concept. Selection of subject document can be automatic, initially selection is based on the body of document central to the concept, or it can be user defined; i.e., the user selects which document to display. The GUI also provides a mechanism for estimating the appropriate cluster diameter-embodied by histogram of cluster size and frequency.

The GUI also advantageously employs incoming links for navigation. These incoming links can be used for sorting and filtering after concept clusters have been created. In general, the node-specific perspective is less important inside cluster because network fragmentation already accounted for. The network perspective of node can help find the center of cluster because the center of the search display will probably have an average number of outgoing links, but will have a statistically significant number of incoming links.

Reference is now made to FIG. 7, which illustrates a flow diagram 700 showing exemplary user interactions with the GUI screen display 600 of FIG. 6. In the initial operating step 702, a user inputs data into the interactive GUI elements by entering one or more search terms in GUI box (step 701) and selects applicable databases for searching via GUI menu 602 (step 703). The system then processes the search parameters in accordance with procedure 400 in FIG. 4 (step 704). The GUI 600 then displays the search results 706 with the active document at the center of the graphical display window 626 and highlighted (628) in the Cluster List pane 610. The text of the active document is displayed in the text window 656 located (in this embodiment) below the graphical window. The user can perform further searches (via branch 707), by returning to the interactive step 702. Alternatively, the user can modify the displayed information from the search by activating the various GUI elements (step 708 via branch 709). The interactive elements that the user can variously employ allow him or her to: (a) select a different document by clicking on it in the graphical display 626 using cursor 644 (step 710); (b) zoom in or out of the field of view of the displayed network of document nodes using slide 648 (step 712); (c) set the diameter of the search using the menu 653 (step 714); (d) hide or show documents not in a selected cluster from the list of clusters in window 610 using button 650 (step 716); (e) hide or show documents not in the selected database with button 652 (step 718); (f) hide documents with fewer than n incoming links using selector 654 (step 720); (g) select a different method for sorting documents in a cluster (e.g. number of incoming links, number of outgoing links, total links, number of links/citations within documents, etc.) using the menu 620 (step 722); (h) selecting different clusters from the list in window 610 by clicking on bullets 612, 614, 616, 618, etc. (step 724); and (i) selecting different documents from the list in window 610 by highlighting the document text and clicking on the text using cursor 644 (step 726). Any of these actions returns the appropriate command to the GUI, to be acted upon via branch 727.

Referring further to the diagram 700 of FIG. 7, when a user desires to place the GUI into a textual mode, to view the text of selected documents listed in window 610, rather than the graphical display 626, the user clicks on the mode switch 665 in the GUI 600 (step 728 via branch 730). This causes the graphical display window 626 to close, and replaces it with a full-sized textual display window 802 that extends the full height of the left-hand side of the switched GUI screen 800 as shown in FIG. 8. The new GUI display 800 now indicates a non-graphical or textual mode (801). The right hand side of the GUI screen 800 contains the same or similar interface components to those described above. Hence, the window 610, histogram 622, menu 620 and other components are numbered in accordance with the description of FIG. 6. Likewise, the same (or similar) database selection menu 602, database listing 604, text search box 606 and search button 608 are employed in this mode. The left hand window 802 now extends the full height of the GUI screen 800. The text 820 of the selected document (in this example, Document G) is listed fully in the window 802. It can be scrolled-through by a scroll bar 806 that resides at the right side of the window 802 in this embodiment. The title of the document is placed in a legend 804 (similar to legend 658 in FIG. 6).

The non-graphical mode allows a single selected document to be displayed in the window 802 based upon highlighting and clicking upon its title (highlight 628) in the list 610 (using cursor 644). Accordingly, the above-described zoom slider 648 and hide buttons 650, 652 and 654 are omitted, as these functions relate to the graphically displayed network, but are unnecessary when displaying a single textual document.

Reference is now made to FIG. 9, which illustrates a flow diagram 900 showing exemplary user interactions with the GUI screen display 800 of FIG. 8. In the initial operating step 902, a user inputs data into the interactive GUI elements by entering one or more search terms in GUI box (step 901) and selects applicable databases for searching via GUI menu 602 (step 903). The system then processes the search parameters in accordance with procedure 400 in FIG. 4 (step 904). The GUI 800 then displays search results 907 with the active document highlighted (628) in the Cluster List pane 610. The text of the active document is displayed in the text window 802 to the left of the Cluster List window 610. The user can perform further searches (via branch 908), by returning to the interactive step 902. Alternatively, the user can change the displayed information from the search in the text box 802 by activating the available GUI elements (step 910 via branch 909). The interactive elements that the user can variously employ allow him or her to: (a) select a different method for sorting documents in a cluster (e.g. number of incoming links, number of outgoing links, total links, number of links/citations within documents, etc.) using the menu 620 (step 920); (b) selecting different clusters from the list in window 610 by clicking on bullets 612, 614, 616, 618, etc. (step 922); and (c) selecting different documents from the list in window 610 by highlighting the document text and clicking on the text using cursor 644 (step 924). Any of these actions returns the appropriate command to the GUI, to be acted upon via branch 927.

Referring further to the diagram 900 of FIG. 9, when a user desires to place the GUI back into graphical mode (see FIG. 6), to view the network of interconnections between selected documents listed in window 610, rather than textual display 802, the user clicks on the mode switch 665 in the GUI 800 (step 928 via branch 930). This causes the textual display window 802 to convert to the lower window, beneath the graphical window 626 (FIG. 6), which graphically displays the connections between document nodes as described above.

It should be clear that the above-described system and method provides a novel and effective technique for deriving search results that are ranked for the user in accordance with their relevance to the search terms provided. These results are displayed in a format that lends itself to a highly graphical representation, comprised of nodes, each representing a document, linked to other documents in the overall corpus of search results. This graphical representation is provided using the above-described GUI with both a graphical display mode, and a non-graphical, display mode, wherein each mode provides the text of selected documents in a desired format.

The foregoing has been a detailed description of illustrative embodiments of the invention. Various modifications and additions can be made without departing from the spirit and scope if this invention. Each of the various embodiments described above may be combined with other described embodiments in order to provide multiple features. Furthermore, while the foregoing describes a number of separate embodiments of the apparatus and method of the present invention, what has been described herein is merely illustrative of the application of the principles of the present invention. For example, the location of DCI data and how the user accesses it are each highly variable as discussed generally above. Placement and layout of GUI components is highly variable. Likewise the types of functional elements employed in the GUI can be varied to suit the particular search application and end users. Accordingly, this description is meant to be taken only by way of example, and not to otherwise limit the scope of this invention.

What is claimed is:

1. A system for searching and displaying text-based and relational information contained within each of a plurality of discrete documents stored in a Document Database (DD), the documents each containing a title and a text body, comprising:
a process that generates a Document Connectivity Index (DCI) defining a list of entries, each entry of the list of entries being a unique entry that is respectively associated with a subject document of the plurality of discrete documents, each unique entry containing links to other entries in the DCI that are referenced to in the text body of the subject document and that reference to the subject document's associated entry; and
a client-initiated process that generates and displays, in response to user-defined search parameters, a sorted list of document clusters based upon the DCI.

2. The system of claim 1 further comprising a process that generates each entry of the DCI by, for each of the documents stored in the DD, creating an associated entry in the DCI with an Index Handle derived from a title of each of the stored documents according to predetermined rules, scanning each of the stored documents for syntax referencing another document title and, when a title of the other document, referenced by the referencing document is identified, adding a link in the associated entry of the referencing document pointing to the associated entry of the referenced document, and adding a link in the associated entry of the referenced document pointing from the associated entry of the referencing document.

3. The system of claim 2 further comprising a process for generating a sorted list of document clusters (SLDC) in response to a user-initiated search by identifying each of the documents in the DD that match the user-defined search parameters and using the DCI to organize the identified documents into clusters, which are then sorted based upon a predetermined criteria.

4. The system of claim 3 wherein the predetermined criteria include at least one of (a) a number of documents in each of the clusters of the SLDC, (b) a number of links in the associated entries for each of the documents in each of the clusters, and (c) a presence or absence of links in the associated entries for each of the documents in each of the cluster.

5. The system of claim 4 further comprising a display of the SLDC on a client computer including:
a graphical representation of each of the clusters in the SLDC as an entry in a list of the clusters, each entry of which having a unique textual identifier,
a graphical representation of each of the documents in the DD being displayed on the client computer as a respective node, each respective node being visually associated with one of the clusters in the SLDC, and
wherein the respective node of the referenced document and the respective node of the referenced document include therebetween a graphical connecting link defining a link therebetween.

6. The system as set forth in claim 5 wherein the graphical representation of each of the clusters and the graphical representation of each of the documents in the DD includes an associated graphical property including at least one of a color, pattern, and shape.

7. The system as set forth in claim 5 wherein the graphical representation of each of the documents in the DD being displayed by the client computer includes a respective node that is free of association with one of the clusters.

8. The system as set forth in claim 5 wherein the graphical connecting link comprises a connecting line having a directional indicator that defines a relationship of the link between the associated entry of the referencing document and the associated entry of the referenced document and wherein the directional indicator includes at least one of color, color gradient, pattern, and shape.

9. The system of claim 5 wherein the each node on the display is constructed and arranged so that, when activated by a user input causes the activated node to be re-centered on the display and causes an node linked thereto by the connecting link to be relocated on the display with respect to the re-centered, activated node and causes document body text corresponding to the activated node to be displayed in a text box on the display.

10. The system of claim 9 wherein each node is constructed and arranged to be activated by at least one of directly applying a cursor to the activated node and manipulating text associated with the node displayed in a box on the display.

11. The system of claim 10 wherein the display includes a selector so that a field of view is selectively zoomed in and zoomed out so as to change a number of displayed nodes.

12. The system of claim 10 wherein the display includes a selector that removes a node from the display according to parameters defined by user input, including at least one of (a) a node with less than a predetermined number of incoming links, (b) a node that is free of association with one or more of the clusters, (c) a node that is free of association with documents that are part of a predetermined document database, and (d) a node that is remote from the activated node by a predetermined number of the connecting links.

13. The system of claim 10 wherein each node is constructed and arranged so that, when contacted with a cursor, the display provides an adjacent pop-up with statistics on the contacted node and the document associated therewith.

14. A method for identifying and navigating clusters of related documents in a document database (DD) in response to a user-initiated text-based search, comprising the steps of:
identifying clusters of related documents relevant to user-defined search parameters, each of the documents in one of the clusters matching the user-defined search parameters, and each of the documents in the one of the clusters referencing or being referenced by at least another of the documents in the one of the clusters; and
displaying the clusters on a client computer, and interactively navigating the clusters to retrieve data on the documents.

15. The method of claim 14 further comprising identifying relevant clusters of related documents by searching the DD for relevant documents matching the user-defined search parameters, and, for each of the relevant documents, associating each of the relevant documents as a subject document with a predetermined cluster of the clusters, the predetermined cluster having associated therewith the subject document, any document referenced by the subject document, and any document already associated with any other document in the cluster.

16. The method of claim 15 further comprising displaying the document clusters on a client computer by:
graphically representing each of the clusters as an entry in a list of the clusters, that is sorted according to criteria including size of each of the clusters, wherein each entry includes a unique textual identifier,
graphically representing each document in the DD being displayed as a respective node, each node being either one of (a) visually associated with at least one of the clusters in the list of clusters, and (b) free of association with any of the clusters, and
wherein the respective node of the referenced document and the respective node of the referenced document include therebetween a graphical connecting link defining a link therebetween to thereby define a connected node-and-link display.

17. The method of claim 16, wherein the step of graphically representing each of the clusters and graphically representing each of the documents in the DD includes displaying an associated graphical property including at least one of a color, pattern, and shape.

18. The method of claim 17 wherein the step of interactively navigating includes:
selecting and activating a predetermined node to display associated body text and re-centering the node within the display in response to user input, the user input including at least one of direct selection of a node by the user, and indirect selection of a node from a textual list,
zooming the node-and-link display in or out;
removing nodes from the display according to parameters defined by user input, including nodes with fewer than a predetermined number of incoming links, nodes that are free of association with any clusters, nodes free of association with any documents that are part of predetermined document databases, and nodes that are remote from the activated node by a predetermined number of the connecting links.

19. The method of claim 14 further comprising pre-processing document connectivity information using a document connectivity index generator that scans the documents in the DD and establishes incoming links and outgoing links between the documents, the links being stored in a document connectivity index and wherein the step of identifying includes accessing the document connectivity index.

20. A system for identifying relevance of and sorting text search results based on connectivity and clustering of documents in a document database, comprising:
a process that identifies clusters of related documents relevant to user-defined search parameters, each of the documents in one of the clusters matching the user-defined search parameters, and each document in the one of the clusters referencing or being referenced by at least one other document in the one of the clusters; and
a process for assigning a relevance score to each of the documents in the one of the clusters based on one of (a) membership in the one of the clusters, and (b) a combination of membership in the one of the clusters and respective text content of each of the documents in relation to user-defined search parameters.
